(19) United States
(12) Patent Application Publication
(10) Pub. No.: US 2010/0023660 A1
(43) Pub. Date: Jan. 28, 2010

(54) KVM SYSTEM

(75) Inventor: Yi-Li LIU, Taipei City (TW)

Correspondence Address: Patterson & Sherldan - ATEN, 3040 Post Oak Boulevard, Suite 1500, Houston, TX, 77056, US

(73) Assignee: ATEN INTERNATIONAL CO., LTD., Shijr City (TW)

(21) Appl. No.: 12/180,195

(22) Filed: Jul. 25, 2008

(51) Int. Cl. G06F 13/38

(52) U.S. Cl. 710/71; 710/65

(57) ABSTRACT

A keyboard-video-mouse (KVM) system is disclosed. The KVM system comprises a module, a KVM switch and a signal cable. The module transmits a single-ended video signal from a computer, converts a universal asynchronous receiver/transmitter (UART) signal to an input/output (IO) signal, and transmits the IO signal to the computer. The KVM switch receives the single-ended video signal from the module and outputs the UART signal to the module. The signal cable transmits the single-ended video signal from the module to the KVM switch and transmits the UART signal from the KVM switch to the first module.

### TECHNICAL FIELD OF THE INVENTION

The present invention relates to a keyboard-video-mouse (KVM) system, and more particularly, to communication in the KVM system.

### BACKGROUND OF THE INVENTION

Communication between a KVM switch and a module (e.g. a dongle) is an important part for designing a KVM system. It has to take many aspects into consideration, such as signal cable, connector, signal converter, and transmitting distance etc. For a well designed KVM system, video signals, keyboard (KB) signals, and mouse (MS) signals can be transmitted therebetween properly.

Here provided two main conventional techniques, D-sub 15 (15-pin VGA connector) based KVM device communication and category 5 (CAT 5) based KVM device communication. Generally, a KVM system utilizing D-sub 15 based KVM device communication is called an analog KVM system in which a common 15-pin VGA connector is often used. Since the size of 15-pin VGA connector is too large, it is not easy to connect much more computers. Generally, a KVM switch can connect at most 16 computers in a 1U system rack if D-sub 15 connectors are used to interface the KVM switch and computers. This may not serve the needs of IT administrators in large corporations. Moreover, a D-sub 15 cable can be 3-in-1. The 3-in-1 D-sub 15 cable provides not only five wires for transmitting video signals but also another five wires for transmitting KB data signals, KB clock signals, KB power signals, MS data signals, and MS clock signals corresponsively, and thus complicate the main board circuit of KVM switch. If a field-programmable gate array (FPGA) is used, a more complicated FPGA will be needed. Furthermore, the 3-in-1 D-sub 15 cable does not transmit USB storage data signals and audio signals.

The conventional CAT 5 based KVM device communication is disclosed in U.S. Pat. No. 6,137,455. For a CAT 5 based KVM device, because RJ-45 connectors are used, which smaller than 15-pin VGA connectors, the KVM switch can connect up to 32 computers in a 1U system rack. However, one of the disadvantages of KVM system utilizing CAT 5 based KVM device communication is that a video encoder circuit and a video decoder circuit are needed. As following, a CAT 5 based KVM system and its disadvantages of needing video encoder and decoder circuits will be described.

Please refer to FIG. 1a. Through a CAT 5 based KVM system, a computer 11 is communicated with a console 12 by transmitting a video signal and an input/output (IO) signal, e.g. a KB signal and/or a MS signal. The CAT 5 based KVM system comprises a module 18, a KVM switch 19 and a CAT 5 cable 13. The video signal from the computer 11 is encoded by a video encoder circuit 171 of the module 18 and then transmitted in the CAT 5 cable 13 to a video decoder circuit 172 of the KVM switch 19. The encoded video signal is decoded by the video decoder circuit 172 and then transmitted to the console 12. In the KVM switch 19, the IO signal from the console 12 is controlled by a controller 161 and converted to a universal asynchronous receiver/transmitter (UART) signal by the signal converter 169. The UART signal is transmitted in the CAT 5 cable 13, converted to the IO signal by the signal converter 159. The IO signal is controlled by a controller 151 in the module 18, and then transmitted to the computer 11.

Please refer to FIG. 1b. The CAT 5 cable 13 has 4 pair of wires, each pair twisted. The video signal and the IO signal are transmitted by utilizing differential signaling transmission. The video signal can be a VGA signal, which comprises R, G, B, H-Sync, and V-sync signals. By differential signaling, the R-signal is signaled as R₊ and R₋ in a twisted pair as shown. Similarly, the G-signal is signaled as G₊ and G₋, the R-signal as R₊ and R₋. The H-Sync signal and the V-sync signal are included when signaling the RGB signal. In addition, the IO signal is converted into the UART signal, which is signaled as U₊ and U₋ in the last twisted pair also by differential signaling. Therefore, the video signal and the IO signal are transmitted.

Since the video signal is transmitted by utilizing differential signaling transmission in the CAT 5 based KVM system, requirement of the video encoder circuit 171 and the video decoder circuit 172 is inevitable. Therefore, video encoder and decoder circuits not only increase the cost of modules and KVM switches, but also increase the response time of video signal to result in a bad performance.

Accordingly, the present invention provides a solution to overcome the above-mentioned disadvantages.

### SUMMARY OF THE INVENTION

To solve the foregoing disadvantages in the conventional techniques, an objective of the present invention is to transmit single-ended video signals in a keyboard-video-mouse (KVM) system directly rather than encode/decode video signals or differential video signals.

Based on the aforesaid objective, an aspect of the present invention is to provide a KVM system. The KVM system comprises a module, a KVM switch and a signal cable. The module transmits a single-ended video signal from a computer, converts a universal asynchronous receiver/transmitter (UART) signal transmitted from the KVM to an input/output (IO) signal, and transmits the IO signal to the computer. The KVM switch outputs the UART signal to the module, and receives the single-ended video signal from the computer via the module and the signal cable. The signal cable connects the KVM switch to the module for transmitting the single-ended video signal from the module to the KVM switch and transmitting the UART signal from the KVM switch to the module. The signal cable has a first RJ-45 male connector at its first end for connecting the KVM and a second RJ-45 male connector at its second end for connecting the module. On the other hand, the KVM switch has a plurality of RJ-45 female connectors to match the first end of the signal cable. The signal cable further has 8 signal wires for carrying the single-ended video signals and UART signal. At least 6 of the 8 signal wires are untwisted and separated.

Another aspect of the present invention is to provide a KVM switch. The KVM switch, which couples a number of computers to at least one console, comprises a video switch, a controller and a signal converter. The video switch switches to one of the computers and routes a single-ended video signal from the computer to the console. The controller manages and processes at least one IO signal from the console. The signal converter converts the IO signal from the controller into an UART signal and signals the UART signal to the computer.

Another aspect of the present invention is to provide a KVM extender, which allows access to a computer from a remote console in the distance. The KVM extender comprises a local unit, a remote unit and a signal cable. The local unit transmits a single-ended video signal from a computer, converts an UART signal to an IO signal, and transmits the IO signal to the computer. The remote unit transmits the single-ended video signal from the local unit to the remote console and outputs the UART signal to the local unit. The signal cable transmits the single-ended video signal from the local unit to the remote unit and transmits the UART signal from the remote unit to the local unit.

Another aspect of the present invention is to provide a KVM system such as matrix KVM system, which allows multiple users control computers simultaneously and independently. The computers can be connected through a combination of multiple matrix KVM switches. In matrix KVM system, for example, a computer couples a first module, a matrix KVM switch and a second module to a console. The first module transmits a single-ended video signal from a computer, converts an UART signal to an IO signal, and transmits the IO signal to the computer. The KVM switch receives the single-ended video signal from the first module and outputs the UART signal to the first module. A first signal cable transmits the single-ended video signal from the first module to the KVM switch and transmits the UART signal from the KVM switch to the first module. The second module transmits the single-ended video signal from the KVM switch, converts the IO signal into the UART signal, and transmits the UART signal to the KVM switch. A second signal cable transmits the single-ended video signal from the KVM switch to the second module and transmits the UART signal from the second module to the KVM switch. A console outputs the IO signal to the second module and receives the single-ended video signal from the second module.

Another aspect of the present invention is to provide a KVM system, which couples a console to at least one computer, and the console sends a plurality of parallel signals for controlling the computer. The KVM system comprises a KVM switch and a module. The KVM switch converts the parallel signals into a bi-directional serial signal in differential mode. The module converts the bi-directional serial signal in differential mode into the parallel signals for controlling the computer. Furthermore, the module transmits at least one single-ended video signal from the computer to the KVM switch. The KVM switch transmits the at least one single-ended video signal to the console.

Another aspect of the present invention is to provide a KVM system, which couples a console to at least one computer, and the console sends a plurality of parallel signals for controlling the computer. The KVM system comprises a KVM switch and a module. The KVM switch converts the parallel signals into at least one uni-directional serial signal. The module converts the uni-directional serial signal into the parallel signals for controlling the computer. Furthermore, the module transmits at least one single-ended video signal from the computer to the KVM switch. The KVM switch transmits the at least one single-ended video signal to the console.

According to the present invention, the single-ended video signal is directly transmitted from the computer to the console. That is, it does not need to encode/decode the video signal. Thus, video encoder/decoder circuits can be eliminated. The cost of producing KVM devices such as modules, KVM switches, KVM extenders or matrix KVM switches, is thereby reduced.

According to the present invention, the IO signal such as a keyboard (KB) signal, a mouse (MS) signal, an USB storage data signal and an audio signal, all are able to be transmitted. All aforesaid signals are converted to the UART signal, which can be transmitted in only two wires of the signal cable. Compared to the conventional D-sub 15 based KVM device, the main board circuit of KVM device in accordance with the present invention is much simpler. If a field-programmable gate array (FPGA) is used, a much cheaper FPGA is enough to work.

A RJ-45 connector can be applied to the interface between the KVM switch and the signal cable, as well as the interface between the signal cable and the module of the present invention. The KVM device can have 32 RJ-45 connecting ports (RJ-45 female connectors) in a 1U system rack to connect up to 32 computers.

### BRIEF DESCRIPTION OF THE DRAWINGS

The present invention will be further described in details in conjunction with the accompanying drawings.

FIG. 1a illustrates a conventional CAT 5 based KVM system.

FIG. 1b illustrates a conventional CAT 5 cable.

FIG. 2a illustrates a KVM system in accordance with the present invention.

FIGS. 2b and 2c illustrate wires of signal cables in accordance with the present invention.

FIG. 3a illustrates a first embodiment implemented with a KVM system in accordance with the present invention.

FIG. 3b illustrates a module in FIG. 3a in accordance with the present invention.

FIG. 3c illustrates a KVM system for the IO signal and the video signal accessible to a network.

FIG. 4 illustrates a second embodiment implemented with a KVM extender in accordance with the present invention.

FIG. 5 illustrates a third embodiment implemented with a matrix KVM system in accordance with the present invention.

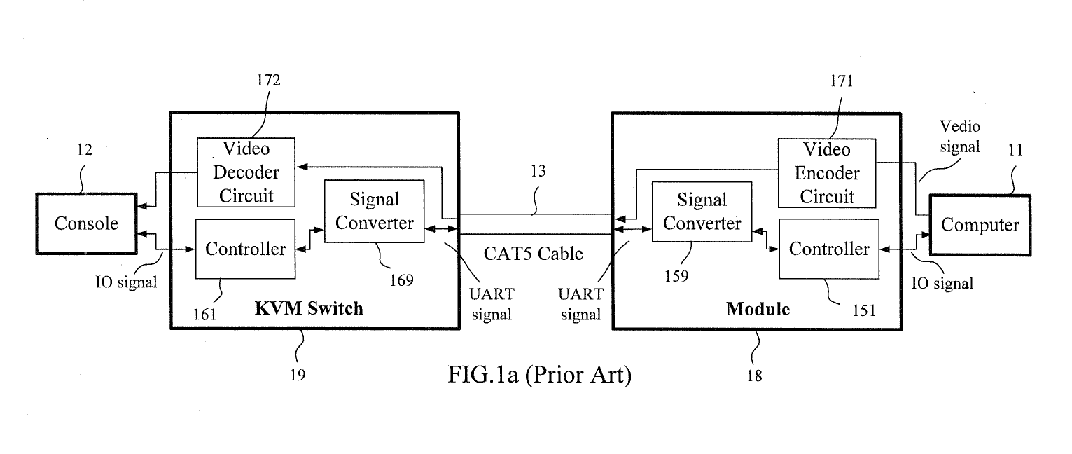

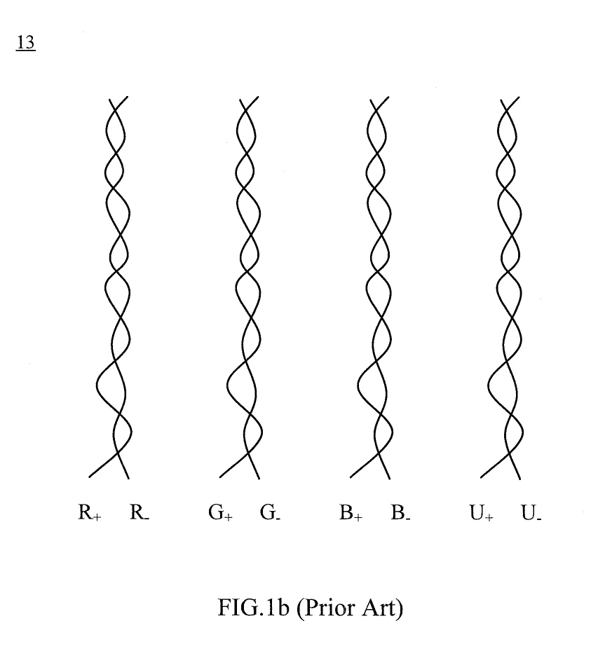

### DETAILED DESCRIPTION OF THE INVENTION

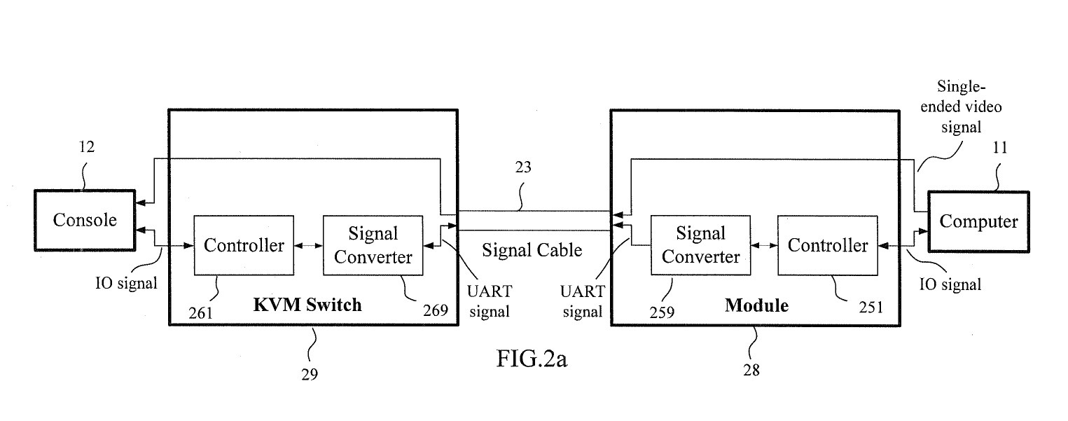

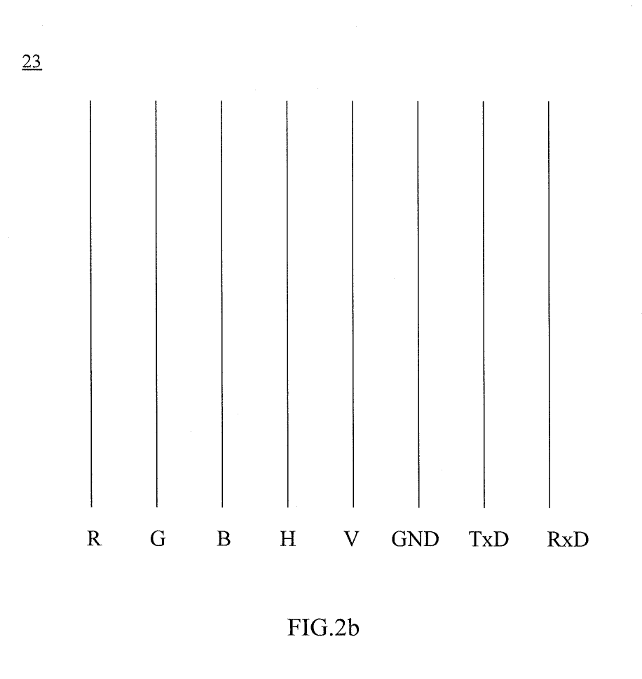

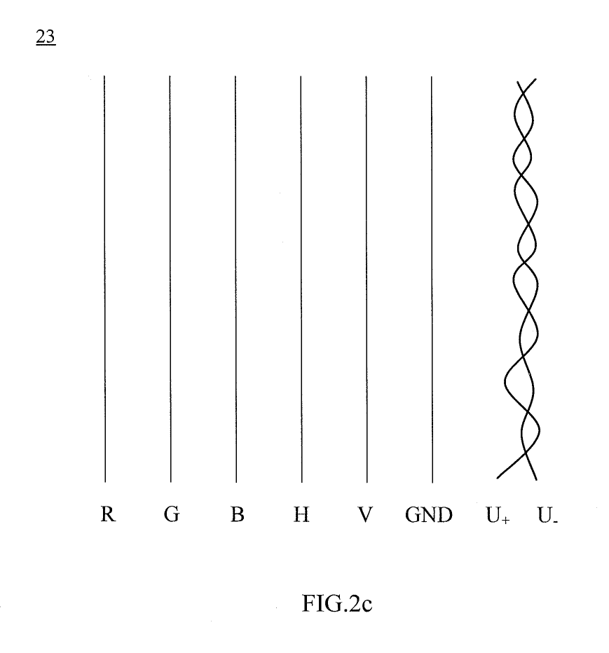

In accordance with the present invention, a single-ended video signal is transmitted. Please refer to FIG. 2a. A KVM system of the present invention comprises a module 28, a KVM switch 29 and a signal cable 23. As shown, a console 12 receives a video signal from a computer 11. The video signal directly transmitted over wires is the so-called single-ended video signal. As shown in FIG. 2a, a single-ended video signal from the computer 11 passes through the module 28 and the KVM switch 29 to the console 12 via the signal cable 23. The single-ended video signal is not encoded or decoded. That is, the video signal transmitted from the computer to the KVM switch has not been transformed to differential signals.

Please refer to FIG. 2b and FIG. 2c, which illustrate wires of the signal cable 23. The single-ended video signal, for example, a VGA signal from a VGA port of the computer, comprises R, G, B, H-sync and V-sync signals. When the single-ended video signal passes through the signal cable 23, the signal cable 23 comprises 5 wires separated for transmitting the R, G, B, H-sync and V-sync signals corresponsively, and one wire grounded.

By transmitting the single-ended video signal, the KVM system of the present invention does not need a video encoder circuit and/or a video decoder circuit, therefore, reducing cost can be achieved. For short distance communication, the image quality of the KVM system of the present invention is better than the conventional CAT 5 based KVM system for the reason that the video signal transmitted by utilizing differential signaling transmission in short distance will be over excited.

Please refer to FIG. 2a. The computer 11 is communicated with the console 12 by transmitting an input/output (IO) signal, e.g. a keyboard (KB) signal, a mouse (MS) signal, an USB storage data signal, a DDC signal, and/or an audio signal through the KVM system of the present invention. These IO signals are collected as parallel signals by a controller 261. The parallel signals are converted into a serial signal by a signal converter 269. Generally, the signal converter 269 can be employed as a universal asynchronous receiver/transmitter (UART), which is a piece of computer hardware that translates data between parallel and serial forms. The UART converts the IO signals (parallel form) into an UART signal (serial form). The signal cable 23 transmits the serial signal to the module 28. The module 28 comprises a signal converter 259 for converting the serial signal to the parallel signals. The parallel signals are transmitted to a controller 251. The signal converter 259 also can be employed as the UART for converting the UART signal (serial form) into the IO signals (parallel form). The controller 251 controls the IO signals and outputs the IO signals to the computer 11. The signal converter 259 and the signal converter 269 can be employed as UART ICs, for example, MAX3110E or MAX3140, manufactured by Maxim Integrated Products. The IO signal from the computer 11 is operated in reverse path. For example, the IO signal from the computer 11 passes through the module 28, the signal cable 23 and the KVM switch 29 in order until received by the console 12. The signal cable 23 has a first RJ-45 connector at its first end for connecting the KVM switch 29 and a second RJ-45 connector at its second end for connecting the module 28. On the other hand, the KVM switch 29 has a plurality of RJ-45 female connectors to match the first end of the signal cable 23. The signal cable 23 further has 8 signal wires for carrying the single-ended video signals and UART signal (serial form). At least 6 of the 8 signal wires are untwisted and separated.

Please refer to FIG. 2b also with FIG. 2a. The serial signal can be transmitted by utilizing non-differential signaling transmission. The signal cable 23 has two separated wires for transmitting uni-directional serial signals, for example, TxD and RxD signals abided by the standard of RS-232 in full-duplex mode, and one grounded wire for grounding. The grounded wire is also used when transmitting the single-ended video signal.

Please refer to FIG. 2c also with FIG. 2a. The serial signal can be transmitted by utilizing differential signaling transmission. The signal cable 23 has a twisted pair of wires for transmitting the serial signal. The serial signal is bi-directionally transmitted in each wire of the twisted pair, so the serial signal is called a bi-directional serial signal. For the UART signal mentioned above, by differential signaling, the UART signal is signaled as U₊ and U₋ in the twisted pair as shown. For example, the UART signal abided by the standard of RS-485 is applicable. Compared with the non-differential signaling transmission, the differential signaling transmission is beneficial for much higher speed to transmit the serial signal.

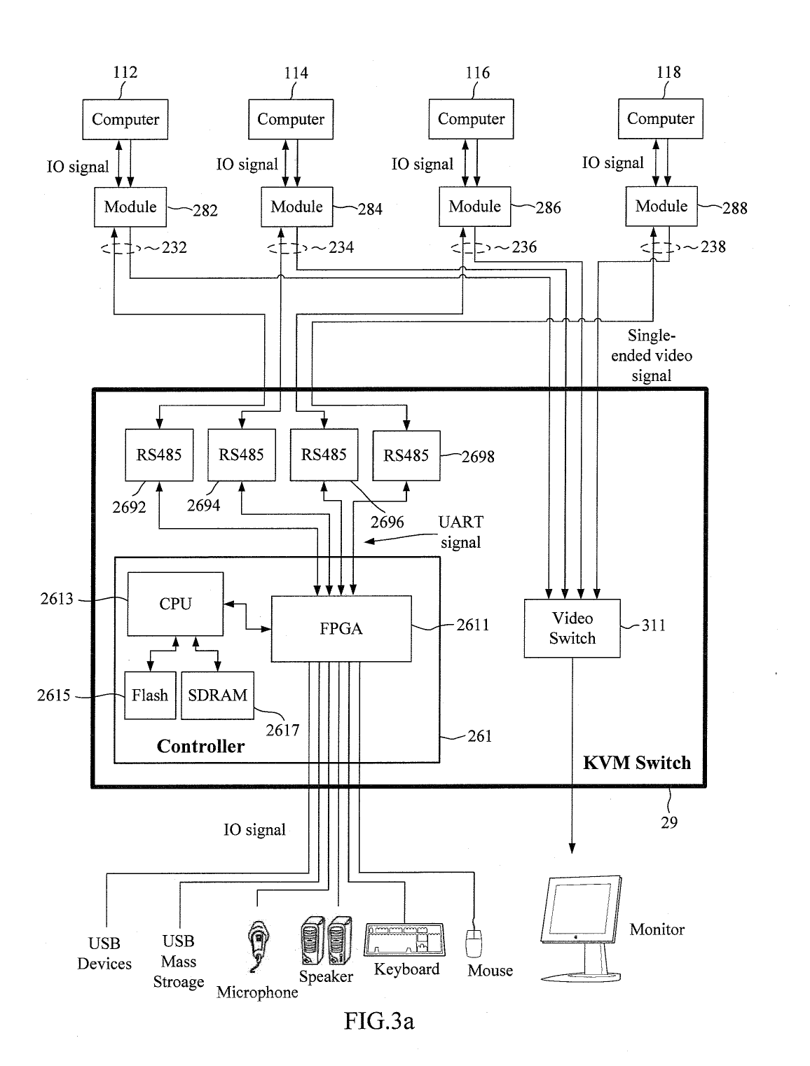

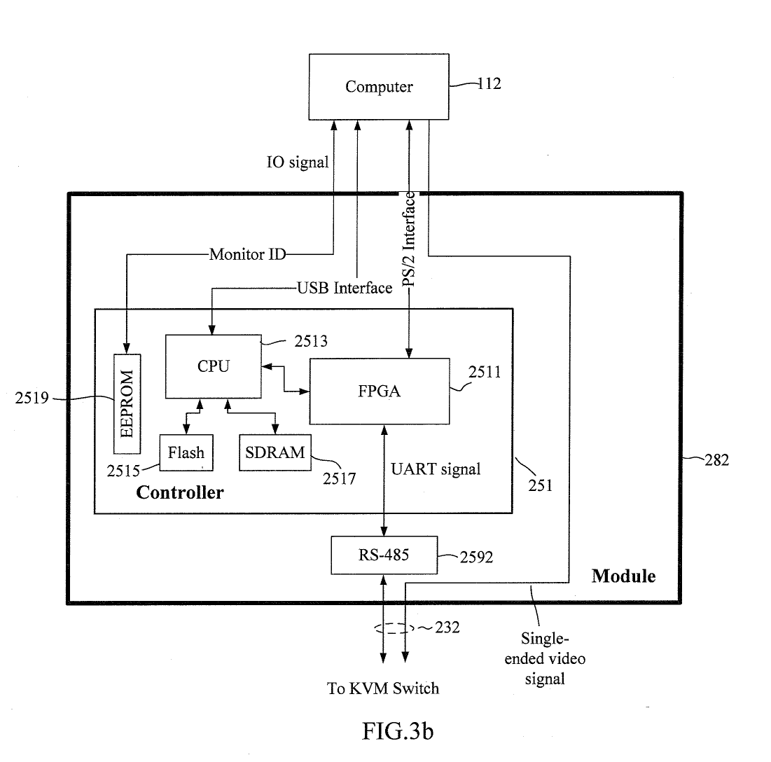

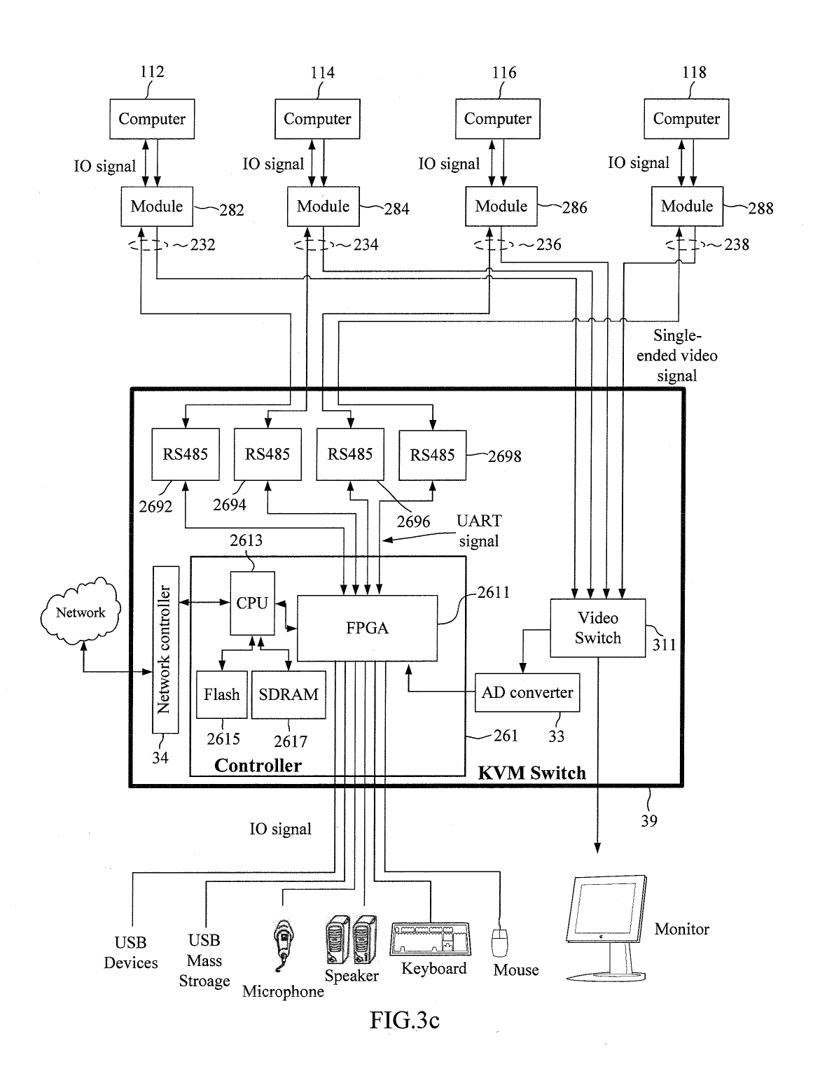

Please refer to FIGS. 3a and 3b. The first embodiment of a KVM system in accordance with the present invention is illustrated. As shown in FIG. 3a, there are 4 computers, computer 112, computer 114, computer 116 and computer 118, coupled to the KVM switch 29. Each computer is accompanied with a module. One module couples one computer to the KVM switch 29. The computer 112 is accompanied with a module 282, the computer 114 with a module 284, the computer 116 with a module 286, and the computer 118 with a module 288. The KVM switch 29 has a video switch 311 to switch to one of the computers and to route a single-ended video signal from the one of the computers to a monitor for display. The KVM switch 29 has a controller 261 to manage and process an IO signal so as to select which computer the IO signal is to be transmitted to. The IO signal may come from a keyboard, a mouse, a speaker, a microphone, an USB mass storage, and/or other USB devices etc. The controller 261 comprises a field-programmable gate array (FPGA) 2611 to manage and a CPU 2613 to process the IO signal in accompany with a Flash memory 2615 and a SDRAM 2617. The FPGA 2611 further converts the IO signal from aforesaid console devices into an UART signal. The FPGA 2611 can be replace by PLD (Programmable Logic Device), PAL (Programmable Array Logic), GAL (Generic Array Logic), CPLD or ASIC. The KVM switch 29 has 4 RS485 transceivers 2692, 2694, 2696 and 2698, correspondingly connected to the modules 282, 284, 286 and 288, respectively via signal cables 232, 234, 236, and 238, for transmitting and receiving the UART signal between the KVM switch 29 and the modules. The RS-485 transceivers can be replaced by RS-232 transceivers. In addition, the IO signal may also comes from the computers 112, 114, 116, and 118 and be transmitted to the console.

Please refer to FIG. 3b. The module 282 is illustrated. The other modules mentioned above are identical to the module 282. The module 282 has a controller 251 to control the IO signal from the computer 112 or to the computer 112. The controller 251 comprises a FPGA 2511, a CPU 2513, a Flash memory 2515, a SDRAM 2517 and an EEPROM 2519. The EEPROM 2519 can store monitor ID. For USB interfaces, the IO signal is transmitted to the CPU 2515 and then passed to the FPGA 2511. For PS/2 interfaces, the IO signal is directly transmitted to the FPGA 2511. The IO signal is further converted to the UART signal by the FPGA 2511. The FPGA 2511 can be replace by PLD (Programmable Logic Device), PAL (Programmable Array Logic), GAL (Generic Array Logic), CPLD or ASIC. The module 282 has a RS-485 transceiver 2592 for transmitting (or receiving) the UART signal to (or from) the corresponding RS485 transceiver 2692 of the KVM switch 29. The RS-485 transceiver 2592 can be replaced with a RS-232 transceiver, correspondingly, the RS485 transceiver 2692 of the KVM switch 29 replaced with a RS-232 transceiver, too.

Please refer to FIG. 3c. The IO signal and the video signal are accessible to a network. The IO signal from the computers 112, 114, 116, 118 can be transmitted to the network. The video signal from the computers 112, 114, 116, 118, also can be transmitted to the network. As shown in FIG. 3c, the video signal is converted into digital signal by an analog-to-digital (AD) converter 33. In FIG. 3c, a network controller 34, for example, a network interface controller (NIC), is used to manage computers on the network to access to this KVM system 39. Accordingly, the computers on the network as console computers can access and control the computers 112, 114, 116, 118. The KVM system 39 with features shown in FIG. 3c is implemented as KVM over IP products.

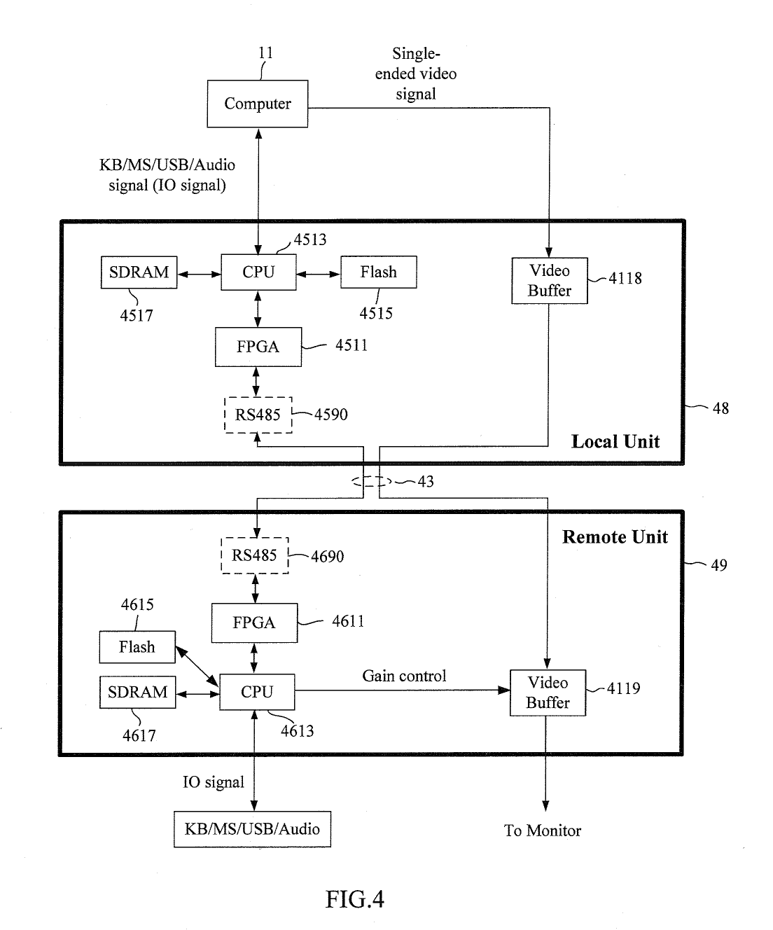

Please refer to FIG. 4. The second embodiment in accordance with the present invention is implemented with a KVM extender. The KVM extender, which allows access to a computer 11 from a console device in the distance, comprises a local unit 48 and a remote unit 49. The local unit 48 is coupled with the computer 11 to transmit a signal-ended video signal and an IO signal to the remote unit 49 via a signal cable 43. The signal cable 43 has a first RJ-45 connector at its first end for connecting the local unit 48 and a second RJ-45 connector at its second end for connecting the remote unit 49. The local unit 48 comprises a FPGA 4511, a CPU 4513, a Flash memory 4515, a SDRAM 4517 and a RS-485 transceiver 4590, and the remote unit 49 comprises a FPGA 4611, a CPU 4613, a Flash memory 4615, a SDRAM 4617 and a RS-485 transceiver 4690. The local unit 48 further comprises a video buffer 4118 for buffering the single-ended video signal so as the remote unit has a video buffer 4119. The CPU 4613 of the remote unit 49 can control the gain of the single-ended video signal. For a short distance, the FPGA 4511 of the local unit 48 and the FPGA 4611 of the remote unit 49 can achieve direct high speed data link (HSDL), thus RS-485 transceivers 4590, 4690 can be omitted. For direct HSDL mode, the RS-485 transceivers 4590, 4690 are waived. For example, the FPGA 4511 and FPGA 4611 can be a master device and a slave device in a two wire communication protocol, such as, I²C.

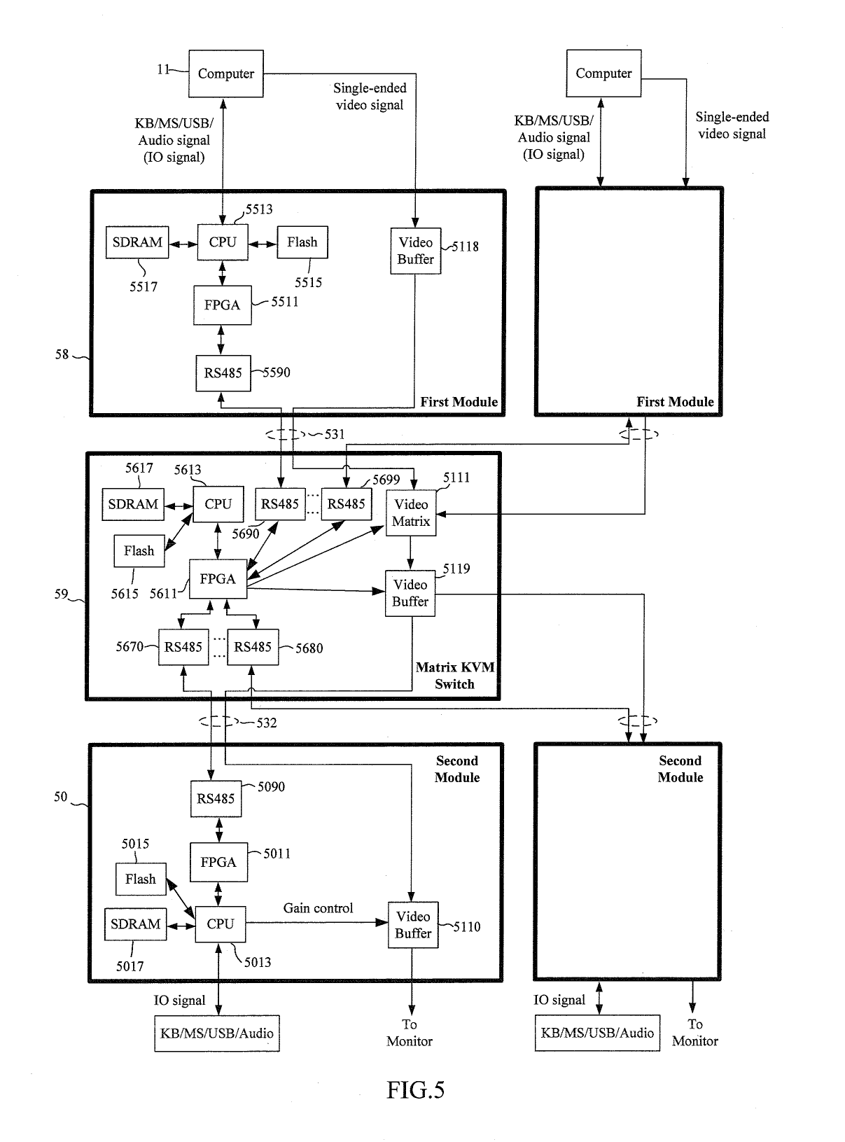

Please refer to FIG. 5. The third embodiment in accordance with the present invention is implemented with a matrix KVM system, which allows multiple users control computers simultaneously and independently. The computers can be connected through a combination of multiple matrix KVM switches. As shown in FIG. 5, a computer 11 is coupled to console devices (KB/MS/monitor/USB/Audio) via a first module 58, a matrix KVM switch 59, and a second module 50. The first module 58 comprises a FPGA 5511, a CPU 5513, a Flash memory 5515, a SDRAM 5517, a RS-485 transceiver 5590 and a video buffer 5118, the matrix KVM switch 59 comprises a FPGA 5611, a CPU 5613, a Flash memory 5615, a SDRAM 5617, numbers of RS-485 transceiver, e.g. a RS-485 converter 5670, 5680, 5690, and 5699, and a video buffer 5119, and the second module 50 comprises a FPGA 5011, a CPU 5013, a Flash memory 5015, a SDRAM 5017, a RS-485 transceiver 5090 and a video buffer 5110. The matrix KVM switch 59 has a video matrix 5111 coupled to the FPGA 5611 to manage the single-ended video signal and route the single-ended video signal from one of computers to a monitor for display. A multiplex can be employed as the video matrix 5111. For an IO signal from a computer 11, the IO signal is converted by the FPGA 5511, transmitted by the RS-485 transceiver 5590, received by the RS-485 transceiver 5690, converted by the FPGA 5611, transmitted by the RS-485 transceiver 5670, received by the RS-485 transceiver 5090, and converted by the FPGA 5011 in order, to the console. There are a first signal cable 531 for connecting the first module 58 to the matrix KVM switch 59, and a second signal cable 532 for connecting the matrix KVM switch 59 to the second module 50. The first signal cable 531 has a first RJ-45 male connector at its first end for connecting the matrix KVM switch 59 and a second RJ-45 male connector at its second end for connecting the first module 58. One the other hand, the KVM switch 59 has a plurality of RJ-45 connecting ports (female connectors) to match the first end of the first signal cable. The first signal cable 531 further has 8 signal wires for carrying the single-ended video signal and UART signal. At least 6 of the 8 signal wires are untwisted and separated. The second signal cable 532 is similar to the first signal cable 531.

The UART signal mentioned above can be transmitted by utilizing non-differential signaling transmission, e.g. RS-232, which communicates in full-duplex mode, or by differential signaling transmission e.g. RS-485, which communicates in half-duplex mode. The signal cable for connecting KVM devices, e.g. a module, a KVM switch, a local unit, a remote unit and a matrix KVM switch etc., may have a RJ-45 male connector.

While the preferred embodiments of the present invention have been illustrated and described in details, various modifications and alterations can be made by persons skilled in this art. The embodiments of the present invention are therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A keyboard-video-mouse (KVM) system, comprising:
a first module, transmitting at least one single-ended video signal from a computer, converting at least one universal asynchronous receiver/transmitter (UART) signal to an input/output (IO) signal and transmitting the IO signal to the computer;
a KVM switch, receiving the single-ended video signal from the first module and outputting the UART signal to the first module; and
a first signal cable, transmitting the single-ended video signal from the first module to the KVM switch, and transmitting the UART signal from the KVM switch to the first module.

2. The KVM system of claim 1, further comprising a console outputting the IO signal to the KVM switch and receiving the single-ended video signal from the KVM switch.

3. The KVM system of claim 2, wherein the IO signal from the console and/or the single-ended video signal from the computer are accessible to a network.

4. The KVM system of claim 1, further comprising:
a second module, transmitting the single-ended video signal from the KVM switch, converting the input/output (IO) signal into the UART signal and transmitting the UART signal to the KVM switch;
a second signal cable, transmitting the single-ended video signal from the KVM switch to the second module, and transmitting the UART signal from the second module to the KVM switch; and
a console, outputting the IO signal to the second module and receiving the single-ended video signal from the second module.

5. The KVM system of claim 1, wherein the single-ended video signal comprises a R-signal, a G-signal, a B-signal, a H-Sync signal and a V-sync signal and the first signal cable comprises five wires separated for transmitting the R-signal, the G-signal, the B-signal, the H-Sync signal and the V-sync signal corresponsively.

6. The KVM system of claim 1, wherein the first signal cable comprises two wires untwisted and separated for transmitting the UART signal by utilizing non-differential signaling transmission.

7. The KVM system of claim 1, wherein the first signal cable comprises two wires twisted for transmitting the UART signal by utilizing differential signaling transmission.

8. The KVM system of claim 1, wherein the first module comprises a first signal converter for converting the UART signal to the IO signal.

9. The KVM system of claim 2, wherein the KVM switch comprises a second signal converter for converting the IO signal from the module to the UART signal.

10. The KVM system of claim 1, wherein the IO signal is selected from a group consisting of a keyboard signal, a mouse signal, a storage data signal and an audio signal.

11. A keyboard-video-mouse (KVM) switch coupling a number of computers to at least one console, comprising:
a video switch, switching to one of the computers and routing at least one single-ended video signal from the computer to the console;
a controller, controlling at least one input/output (IO) signal from the console; and
a signal converter, converting the IO signal from the controller into a universal asynchronous receiver/transmitter (UART) signal and signaling the UART signal to the computer.

12. The KVM switch of claim 11, wherein the UART signal is signaled by utilizing non-differential signaling.

13. The KVM switch of claim 11, wherein the UART signal is signaled by utilizing differential signaling.

14. A keyboard-video-mouse (KVM) extender, comprising:
a local unit, transmitting a single-ended video signal from a computer, converting a universal asynchronous receiver/transmitter (UART) signal to an input/output (IO) signal and transmitting the IO signal to the computer;
a remote unit, transmitting the single-ended video signal from the local unit to a console, and outputting the UART signal to the local unit ; and
a signal cable, transmitting the single-ended video signal from the local unit to the remote unit, and transmitting the UART signal from the remote unit to the local unit.

15. The KVM extender of claim 14, wherein the single-ended video signal comprises a R-signal, a G-signal, a B-signal, a H-Sync signal and a V-sync signal and the signal cable comprises five wires separated for transmitting the R-signal, the G-signal, the B-signal, the H-Sync signal and the V-sync signal corresponsively.

16. The KVM extender of claim 14, wherein the signal cable comprises two wires separated for transmitting the UART signal by utilizing non-differential signaling transmission.

17. The KVM extender of claim 14, wherein the signal cable comprises two wires twisted for transmitting the UART signal by utilizing differential signaling transmission.

18. A keyboard-video-mouse (KVM) system, for coupling a console to at least one computer, the console sending a plurality of parallel signals for controlling the computer, the KVM system comprising:
a KVM switch, converting the plurality of parallel signals into a bi-directional serial signal in differential mode;
a module, converting the bi-directional serial signal in differential mode into the plurality of parallel signals for controlling the computer;
wherein the module further transmitting at least one single-ended video signal from the computer to the KVM switch; and
wherein the KVM switch further transmitting the at least one single-ended video signal to the console.

19. The KVM system of claim 18, further comprises a signal cable, for connecting the module to the KVM switch, and transmitting the bi-directional serial signal in differential mode and the at least one single-ended video signal.

20. The KVM system of claim 19, wherein the signal cable further comprises a first RJ-45 male connector at a first end for connecting the KVM switch and a second RJ-45 male connector at a second end for connecting the module.

21. The KVM system of claim 19, wherein the signal cable further comprises a pair of twisted wires for carrying the bi-directional serial signal in differential mode and 6 separate wires for carrying the at least one single-ended video signal.

22. The KVM system of claim 20, wherein the KVM switch farther comprises a plurality of RJ-45 connecting ports to match the first end of the signal cable.

23. The KVM system of claim 22, wherein the KVM switch further comprises height not more than 1U.

24. The KVM system of claim 23, wherein the KVM switch further comprises at least 32 RJ-45 connecting ports.

25. A keyboard-video-mouse (KVM) system, for coupling a console to at least one computer, the console sending a plurality of parallel signals for controlling the computer, the KVM system comprising:
a KVM switch, converting the plurality of parallel signals into at least one uni-directional serial signal;
a module, converting the unidirectional serial signal into the plurality of parallel signals for controlling the computer;
wherein the module further transmitting at least one single-ended video signal from the computer to the KVM switch; and
wherein the KVM switch further transmitting the at least one single-ended video signal to the console.

26. The KVM system of claim 25, further comprises a signal cable, for connecting the module to the KVM switch, and transmitting the uni-directional serial signal and the at least one single-ended video signal.
